(19) United States
(12) Patent Application Publication
(10) Pub. No.: US 2022/0408534 A1
(43) Pub. Date: Dec. 22, 2022

(54) ELECTRONIC DEVICE IDENTIFICATION SYSTEM

(71) Applicant: DANIEL R. JUDD, BURLINGTON, MA (US)

(72) Inventor: DANIEL R. JUDD, BURLINGTON, MA (US)

(21) Appl. No.: 17/304,401

(22) Filed: Jun. 21, 2021

(51) Int. Cl. H05B 47/19; H05B 45/20; H05B 45/32; G08B 5/38

(52) U.S. Cl. CPC H05B 47/19; H05B 45/20; H05B 45/32; G08B 5/38

(57) ABSTRACT

A system and method is described that enables an observer to quickly and easily identify specific and individual distributed electronic devices from a collection of dozens, or with variations up to hundreds of thousands. The solution is simultaneously active on all of the devices, is reconfigurable at any time, and only requires specifically defined colored optical patterns generated at each device to be in the observer's visual range. Implementable with a single LED display the system is easily adapted to limited space applications and incurs minimal cost.

### FIELD OF THE INVENTION

The present invention relates to electronic device identification systems and methods, especially to unique visual identification of distributed electronic devices.

### DESCRIPTION OF THE PRIOR ART

There are numerous examples of electronic device identification systems in the prior art. Shortcomings in the prior art when compared to the present invention include in various combinations: the inability to identify specific and individual distributed electronic devices out of a plurality of dozens, or with variations up to hundreds of thousands, to an observer in a manner that is: easy, fast, simultaneously active on all the devices, and does not require proximity closer than the visual range of the emitted colored light, for example beyond safety or security barriers. Also, the present invention compares favorably to numerical or textual displays because it is reduced to practice with a single LED display which is low cost and easily adapted to limited space applications.

Nooner discloses in US patent application US 2019/0065924 A1 published Feb. 28, 2019, an electronic tracking device that attaches to a beverage container that includes a light indicator that responds to wireless communication. Nooner further discloses in US patent application US 2020/0184304 A1 published on Jun. 11, 2020, an electronic device that measures either temperatures or accelerations of a beverage container to which it is fastened, along with communications means and one or more visual or audible indicators. In one disclosed embodiment common to both patent applications, “one or more LEDs of optionally different colors can be controlled to convey different information based on the color and/or type of light emission. For example, connection established, flashing green light; communication in progress, solid white light; location identification, pulsating blue light; alarm, fast flashing red light; low battery, slow flashing orange light; etc.” “The light emissions and their associated meanings can be customized consistent with the disclosure.”

Bloom et al. discloses in U.S. Pat. No. 10,915,860 issued on Feb. 9, 2021, a system for tracking and locating beverage and food containers in a commercial setting such as a restaurant or store, where each item to be tracked has affixed thereto an electronic device that is wirelessly communicating with a control computer, and that has a display and/or visible light LEDs on its surface. The display and LEDs can be controlled to help identify each device, by for example activating an LED to provide visual communication with a user.

These three examples of prior art differ from the present invention, where the LED(s) and control electronics are integrated into the article being identified. The present invention uses the one or more LEDs to uniquely identify the article in which it is integrated, rather than provide an indication of an operation or status. Furthermore, the LEDs of the present invention can be controlled to have a color pulse pattern over time that is unique for each article. Furthermore, the LEDs of the present invention can have an emission color variation over time that is unique for each article. In this way, the present invention creates a system for simultaneously visually identifying a plurality of articles, each with a unique characteristic such as a serial number, function, location, etc. Furthermore, the present invention discloses preferred embodiments that maximize the ability of a user to quickly discern the identity of an article by using carefully selected color variations.

There have been numerous prior art disclosures of signaling or communicating status and warnings to passengers in one vehicle, or between vehicles. For example, Armstrong discloses in U.S. Pat. No. 6,982,637 issued Jan. 3, 2006 a method for controlling vehicle lights in a flash sequence to communicate with the vehicle occupants or external observers. In U.S. Pat. No. 6,154,126 issued Nov. 28, 2000, Beasely et al. disclose a vehicle signaling system to enable communication of messages between vehicles in an effort to improve road safety and to reduce negative effects of road rage. The present invention differs from this prior art by controlling the color and flash sequence of at least one indicator to provide a unique identification of the device in which the invention is integrated. The present invention is visually indicating the unique identity of the device to an observer.

To overcome the shortcomings, the present invention provides an improved electronic device identification system to mitigate or obviate the aforementioned problems.

### SUMMARY OF THE INVENTION

The main objective of the present invention is to provide a low cost and compactly sized system and method for identification of specific and individual distributed electronic devices out of a plurality of dozens, or with variations up to hundreds of thousands, to an observer in a manner that is: easy, fast, simultaneously active on all the devices, and does not require proximity closer than the visual range of the emitted colored light.

Other objectives, advantages and novel features of the invention will become more apparent from the following detailed description when taken in conjunction with the accompanying drawings.

### BRIEF DESCRIPTION OF THE DRAWINGS

FIG. 1 is a timing diagram of a color pulse pattern in accordance with the present invention;

FIG. 2 is a block diagram of an electronic device identification system in accordance with the present invention;

FIG. 3 is a chromaticity chart with colors identified in accordance with the present invention;

FIG. 4 is block diagram of a distributed electronic device in accordance with the present invention;

FIG. 5 is a flow chart for a method of electronic device identification in accordance with the present invention;

FIG. 6 is a collection of flow charts for methods of electronic device identification in accordance with the present invention.

### DETAILED DESCRIPTION OF THE INVENTION

The invention disclosed herein refers to embodiments of an electronic device identification system for distributed electronic devices providing observers identification of specific individual devices out of a plurality of dozens, or with variations up to hundreds of thousands, that is easily and quickly discernable, often in under 3-5 seconds, simultaneously active on all devices, and usable over distances up to the visual range of the emitted colored light.

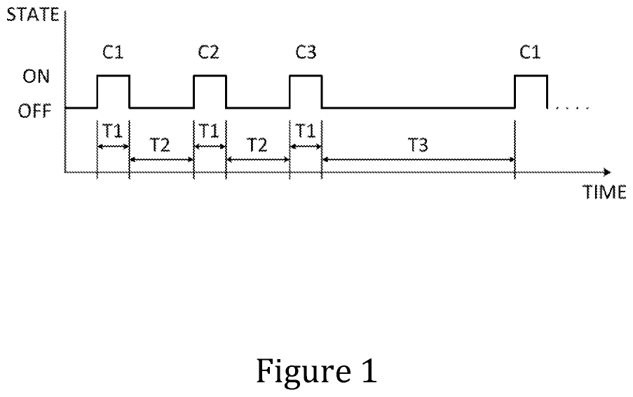

With reference to FIG. 1, a preferred embodiment of the present invention comprises means for the emission of colored light pulses over time in predefined repeating patterns, where colored light (C1), (C2), and (C3) is emitted in short pulses (T1) separated by short pauses (T2) and where this sequence is followed by a pause (T3) that is longer in time than the pause separating the short pulses (T2) before the pattern repeats.

Colors (C1), (C2), and (C3) are selected from a finite list of easily distinguishable colors and create a pattern used to uniquely identify distributed electronic devices from a plurality of devices numbering in quantity limited only by the number of available colors raised to the power of the number of pulses, such as 7 color possibilities and 3 pulses yielding 343 unique color pulse patterns.

Another preferred embodiment of the present invention comprises means for the emission of 7 color possibilities and 2 color light pulses yielding 49 unique color pulse patterns, whereby patterns of 3 or fewer color pulses are relatively easy to discern for a common observer and patterns of 2 or fewer pulses are easier still.

Another preferred embodiment of the present invention comprises means for the emission of 2 sequences, of 2 pulses each as previously described, where the entire pattern of 2 sequences is separated in time by a pause longer than the pause separating the 2 sequences (T3) in such a manner that with 7 color possibilities a total of 2,401 unique color pulse patterns are available with all patterns limited in complexity in accordance with an easily discernable pattern for a common observer.

Another preferred embodiment of the present invention comprises means for the emission of 2 sequences, of 3 pulses each as previously described, where the entire pattern of 2 sequences is separated in time by a pause longer than the pause separating the 2 sequences (T3) in such a manner that with 7 color possibilities, a total of 117,649 unique color pulse patterns are available with patterns that are more complex than previously described color pulse patterns and approach the limit of discernibility for most common observers.

Another preferred embodiment of the present invention comprises a color pulse pattern configured for use with more than one distributed electronic device in a manner consistent with the identification of device groups wherein the electronic device identification system provides means for identifying distributed electronic devices individually or as a member of a group.

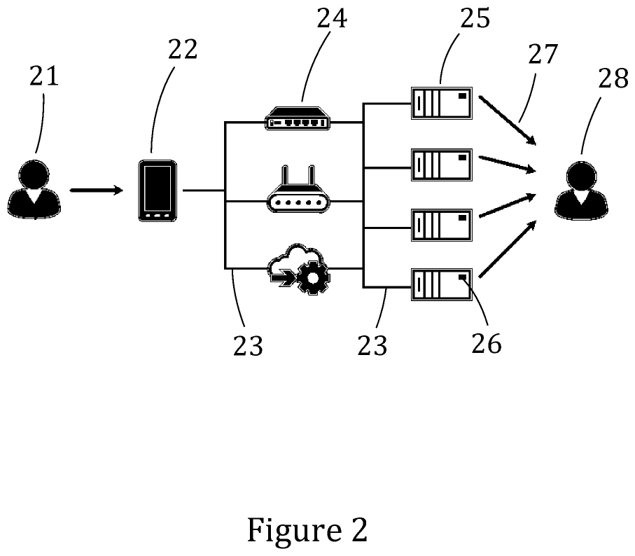

With reference to FIG. 2, a preferred embodiment of the present invention comprises a configuration interface (22) accessed by an operator (21) who configures distributed electronic devices (25) either directly or over communication connections (23) that are wired or wireless, networked or single path, physical or logical, with optional active network components (24), such that multicolored optical indicators (26) are configured to emit color pulse patterns in accordance with the present invention that are visible over optical viewing paths (27) to an observer (28).

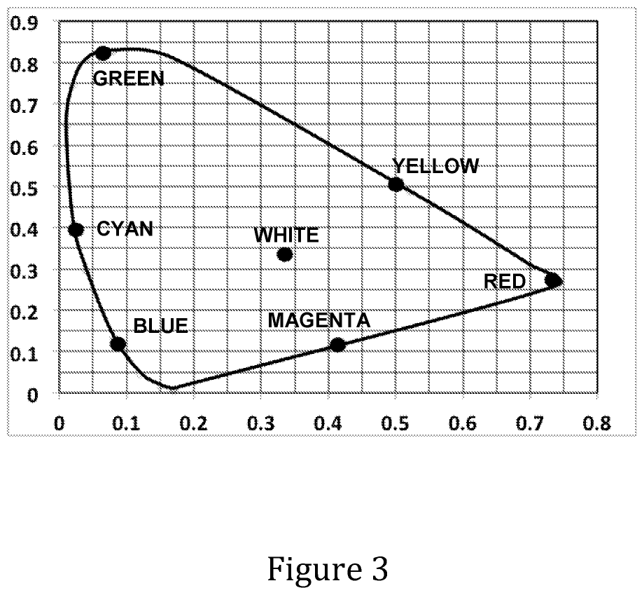

With reference to FIG. 3, a preferred embodiment of the present invention comprises the set of selectable colors available from the list of red, green, blue, cyan, magenta, yellow, and white, in accordance with a maximized chromaticity separation as determined by a plot on a CIE (International Commission on Illumination) chromaticity chart, whereby providing colors limited to a set of those most readily discernable for common observers.

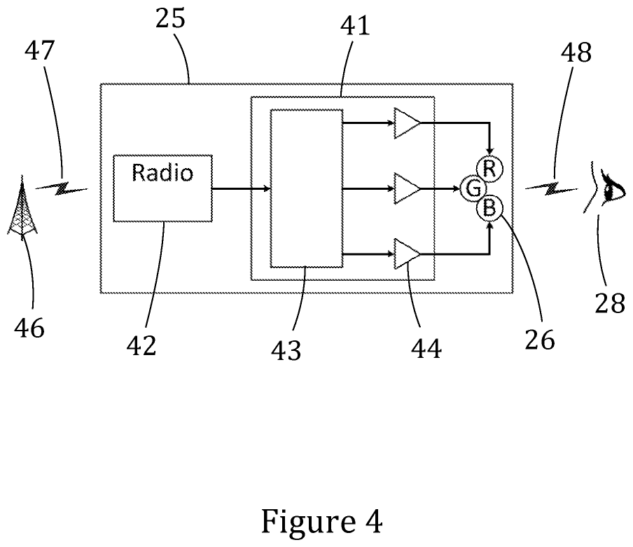

With reference to FIG. 4, a preferred embodiment of the present invention comprises a distributed electronic device (25) with red, green, blue (RGB) light emitting diode (LED) indicator (26), a radio receiver (42), and a configurable electronic controller (41) comprising a pattern storage and processing unit (43), and LED drivers (44) providing means for wireless communication (47) from a radio transmitter (46) able to configure the pattern storage and processing unit (43) with a color pulse pattern that is displayed with colored light (48) to an observer (28). This embodiment of the present invention is reduced to practice with a single LED display component which is low cost and easily adapted to limited space applications.

Another preferred embodiment of the present invention comprises distributed electronic devices powered by an external power source or by an internal battery.

With reference to FIG. 1, a preferred embodiment of the present invention comprises color pulse patterns with timing parameters in accordance with ease of discernment for a common observer such that: on times (T1) are in the range of 10 to 500 milliseconds and more preferably 20 to 300 milliseconds and most preferably 50 to 125 milliseconds; pause times between pulses (T2) are in the range of 50 to 2000 milliseconds and more preferably 100 to 800 milliseconds and most preferably 200 to 300 milliseconds; and pause times between repeating patterns (T3) are in the range of 200 to 10000 milliseconds and more preferably 300 to 5000 milliseconds and most preferably 500 to 1000 milliseconds.

Other preferred embodiments of the present invention comprise distributed electronic devices selected from the list of: bioelectric signal sensing device, biomedical device, sensor device, actuator device, active network device, network router, drone, wearable device, internet of things (IoT) device, factory automation input-output device, and industrial network device of at least one of master or slave, client or server, and publisher or subscriber.

With reference to FIG. 1, a preferred embodiment of the present invention comprises means for the control of the pause time between repeating patterns (T3) in order to indicate a state or operational mode of the distributed electronic device, such as a value of 500 milliseconds indicating a device that is actively searching for a network connection and a value of 1500 milliseconds indicating a device that is connected, alternatively a value of 1500 milliseconds indicating a device that is operating normally and a value of 500 milliseconds indicating a device that is in an operational exception state such as processing error or battery fault condition, or alternatively values of 500, 1500 and 3000 milliseconds respectively used to indicate 1 of 3 states or conditions.

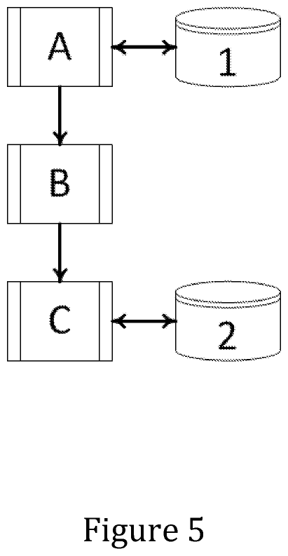

With reference to FIG. 5, a preferred embodiment of the present invention comprises electronic device identification method consisting of the 3 steps of: first step (A) associating in a virtual or actual indexed selection table a color pulse pattern with a distributed electronic device's identifying index, label, or reference and optionally storing said association in a centralized storage unit (1); second step (B) deploying each distributed electronic device in accordance with its intended application, identifying label, or reference; and third step (C) communicating to each distributed electronic device its associated color pulse pattern selection or color pulse pattern table index which is then stored in storage unit (2) that is contained within or associated with each distributed electronic device.

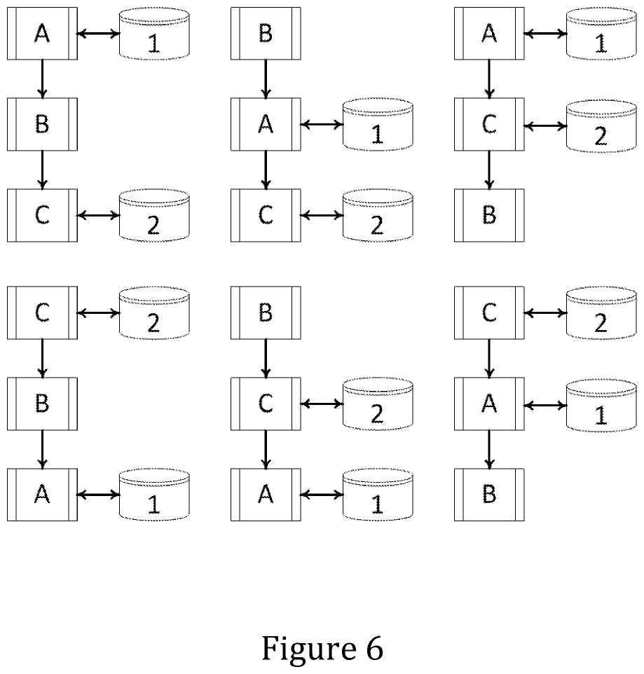

With further reference to FIG. 6, a preferred embodiment of the present invention comprises electronic device identification method where one or more of the 6 possible permutations in the order of the aforementioned 3 steps (A), (B), and (C) is implemented.

Even though numerous characteristics and advantages of the present invention have been set forth in the foregoing description, together with details of the structure and features of the invention, the disclosure is illustrative only. Changes may be made in the details, especially in matters of colors, number of pulses, pulse timing, and operational procedures within the principles of the invention to the full extent indicated by the broad general meaning of the terms in the appended claims as expressed.

What is claimed is:

1. A system for uniquely visually identifying each of a plurality of distributed electronic devices, with said system comprising:
means for identifying said devices using unique color pulse patterns which are a sequence of one or more distinct visual color pulses that repeats in time;
with at least one configuration means that selects a color pulse pattern, preferably associates said pattern with an identifying label or reference, and communicates said pattern selection to one or more distributed electronic devices;
where each distributed electronic device comprises at least one multicolored optical indicator and a related configurable electronic controller;
and where said devices display said patterns for visual indication of an individual or group identification.

2. The system of claim 1 where the unique color pulse pattern is a repeating sequence of 3 or fewer pulses.

3. The system of claim 1 where the visual indication is a repeating color sequence of 3 or fewer pulses with:
on times in the range of 10 to 500 milliseconds and more preferably 20 to 300 milliseconds and most preferably 50 to 125 milliseconds,
pause time between pulses in the range of 50 to 2000 milliseconds and more preferably 100 to 800 milliseconds and most preferably 200 to 300 milliseconds,
and pause time between repeating patterns in the range of 200 to 10000 milliseconds and more preferably 300 to 5000 milliseconds and most preferably 500 to 1000 milliseconds.

4. The system of claim 1 where the colors available for the sequence are selected from the list of: red, green, blue, cyan, magenta, yellow, and white.

5. The system of claim 1 where communication to the distributed electronic device is achieved using a wireless radio.

6. The system of claim 1 where the distributed electronic device is battery powered.

7. The system of claim 1 where the electronic means to control at least one multicolored optical indicator is selected from the list of a microcontroller, microprocessor, and programmable gate array.

8. The system of claim 1 where the at least one multicolored optical indicator is selected from the list of a light emitting diode (LED), liquid crystal display (LCD), electrophoretic indicator, and electrochromic indicator.

9. The system of claim 1 where the distributed electronic device is selected from the list of: bioelectric signal sensing device, biomedical device, sensor device, actuator device, active network device, network router, drone, wearable device, internet of things (IoT) device, factory automation input-output device, and industrial network device of at least one of master or slave, client or server, and publisher or subscriber.

10. The system of claim 1 where the unique color pulse pattern is a repeating sequence of at least 2 groupings of 3 or fewer pulses each, with pause time between groupings longer than the pause time between pulses and shorter than the pause time between patterns.

11. The system of claim 3 where the pause time between repeating patterns is varied and used to indicate a state or operational mode of the distributed electronic device.

12. A method for uniquely visually identifying each of a plurality of distributed electronic devices, with said method comprising the three steps of:
associating in a virtual or actual indexed selection table a color pulse pattern, comprised of a sequence of one or more distinct visual color pulses that repeats in time, with an index identifier and preferably with a distributed electronic device's identifying label or reference;
deploying each distributed electronic device in accordance with its intended application, or identifying label or reference;
and communicating to each distributed electronic device its associated color pulse pattern selection or color pulse pattern table index.

13. The method of claim 12 where the order of the 3 steps can be interchanged to simplify the deployment of the method.
